(19) United States
(12) Patent Application Publication
(10) Pub. No.: US 2025/0206233 A1
(43) Pub. Date: Jun. 26, 2025

(54) CENTER CONSOLE FOR VEHICLE

(71) Applicant: HONDA MOTOR CO., LTD., Tokyo (JP)

(72) Inventors: Takahiro Sato, Tokyo (JP); Ryu Tate, Tokyo (JP); Takeshi Matsushita, Tokyo (JP); Yoshiki Misawa, Tokyo (JP)

(21) Appl. No.: 18/981,716

(22) Filed: Dec. 16, 2024

(30) Foreign Application Priority Data
Dec. 26, 2023 (JP) 2023-220109

(51) Int. Cl. B60R 7/04; B60H 1/00; B60R 11/00; B60R 11/02

(52) U.S. Cl. CPC B60R 7/04; B60H 1/00564; B60R 11/0217; B60R 2011/0007

(57) ABSTRACT

A center console for a vehicle includes a plurality of control units disposed inside the vehicle at the front in the center console, and a sound source disposed inside the vehicle at the rear in the center console. The sound source is disposed facing toward lateral sides of the vehicle.

### CROSS-REFERENCE TO RELATED APPLICATION

Priority is claimed on Japanese Patent Application No. 2023-220109, filed Dec. 26, 2023, the content of which is incorporated herein by reference.

### BACKGROUND OF THE INVENTION

### Field of the Invention

The present invention relates to a center console for a vehicle.

### Description of Related Art

In recent years, as development of electric vehicles has become more active, many proposals have been made regarding disposition of control units (ECUs). For example, Patent Document 1 listed below describes a vehicle in which a power conversion device is disposed inside a center console.
[Patent Document 1] Japanese Unexamined Patent Application, First Publication No. 2014-96908

### SUMMARY OF THE INVENTION

When it comes to acoustics inside a vehicle compartment, an increasing number of vehicles are having multiple speakers disposed therein, but there are challenges with the layout of disposing the speakers.

Aspects according to the present invention have been made in consideration of the foregoing circumstances, and an object thereof is to provide a center console for a vehicle in which a control unit and a sound source can be disposed compactly.

In order to resolve the foregoing problems and achieve the object, the present invention employs the following aspects.

(1) A center console for a vehicle according to the present invention includes a plurality of control units disposed inside the vehicle at the front in the center console, and a sound source disposed inside the vehicle at the rear in the center console. The sound source is disposed facing toward lateral sides of the vehicle.

With the foregoing constitution, even if a large occupancy area is secured for the sound source, it can be disposed compactly together with the control unit inside the center console.

(2) In the foregoing aspect (1), the center console may include a box for securing a space for the sound source, and the box may be disposed below a front passenger seat of the vehicle in an extending manner.

In this case, a space for disposing the box for the sound source can be secured by effectively utilizing a dead space below the front passenger seat.

(3) In the foregoing aspect (1), the center console for a vehicle may further include an air conditioning duct lying on an upper surface of the sound source between the control unit and the sound source from a lower surface of the control unit.

In this case, the air conditioning duct can be disposed compactly together with the control unit and the sound source inside the center console.

(4) In the foregoing aspect (1), the center console may include a cover accommodating at least the control unit and the sound source, and the cover may have an opening portion communicating with the control unit and the sound source.

In this case, exhaust heat of the control unit and sound pressure of the sound source can be released to the outside of the center console.

(5) In the foregoing aspect (4), the opening portion may be disposed at a position overlapping a seat cushion of the vehicle.

In this case, the opening portion for releasing exhaust heat of the control unit and sound pressure of the sound source is disposed such that it is less likely to be seen from a passenger so that the interior appearance can be improved.

According to the aspects of the present invention, a control unit and a sound source can be disposed compactly.

### BRIEF DESCRIPTION OF THE DRAWINGS

FIG. 1 is a plan view schematically showing the inside of a vehicle compartment of a vehicle.

FIG. 2 is a perspective view showing an example of an exterior appearance of a center console.

FIG. 3 is a perspective view showing an example of a positional relationship between a sound source in the center console and a passenger seat.

FIG. 4 is a perspective view showing an example of disposition of equipment built into the center console.

FIG. 5 is a side view showing an example of disposition of a duct in the center console.

FIG. 6 is a rear view showing an example of disposition of the equipment built into the center console.

FIG. 7 is a side view showing an example of disposition of an opening portion with respect to a seat cushion.

### DETAILED DESCRIPTION OF THE INVENTION

Hereinafter, the present invention will be described on the basis of a preferred embodiment.

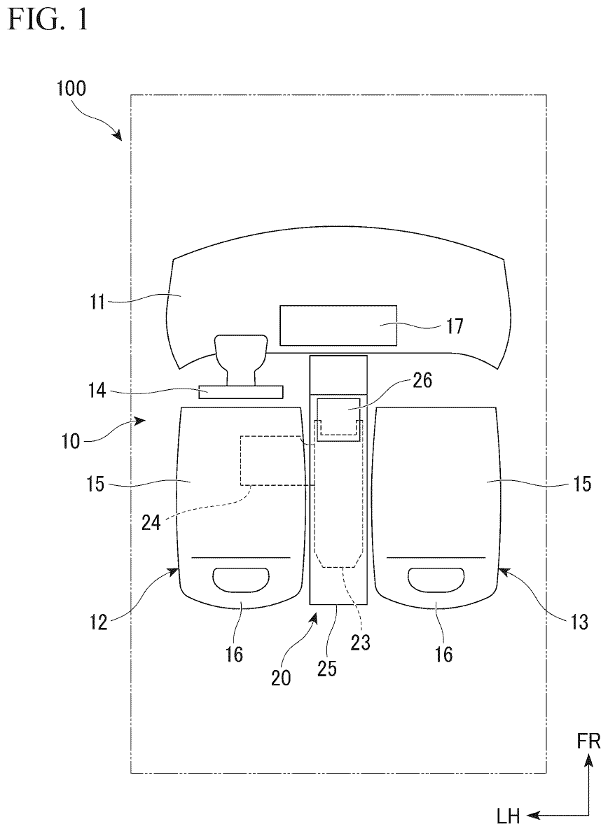

FIG. 1 is a plan view schematically showing the inside of a vehicle compartment 10 including a center console 20 of a vehicle 100 of the present embodiment. FIG. 1 shows an arrow FR indicating the front side of the vehicle 100 and an arrow LH indicating the left side of the vehicle 100. The upward side of the vehicle 100 is the side in front of the page.

The vehicle 100 includes an instrument panel 11, a driver's seat 12, a passenger seat 13, a steering wheel 14, and the like inside the vehicle compartment 10.

The driver's seat 12 is a seat disposed at the front in the vehicle 100 and used by a driver. The passenger seat 13 is a seat disposed next to the driver's seat 12 at the front in the vehicle 100 and used by a passenger other than the driver. The driver's seat 12 and the passenger seat 13 are front passenger seats disposed at the front in the vehicle 100.

Although it will not be particularly shown, one or more rows of passenger seats may be provided behind the front passenger seats inside the vehicle compartment 10. A passenger sitting in the passenger seat 13 may or may not assist the driver during driving of the vehicle 100, and there may be no fellow passenger in the passenger seat 13. In the vehicle 100 of the illustrated example, the driver's seat 12 is disposed on the left side of the passenger seat 13. However, on the contrary to the illustrated example, the driver's seat 12 may be disposed on the right side of the passenger seat 13. The number, disposition, and the like of seats are not limited to the illustrated example and may be suitably changed.

Each of the seats, such as the driver's seat 12 and the passenger seat 13, includes a seat cushion 15 on which a passenger sits down, and a backrest 16 against which a passenger sits back. The position of the seat cushion 15 may be adjustable or changeable in a forward-rearward direction, or the position thereof in the forward-rearward direction may be fixed. The inclination of the backrest 16 with respect to the seat cushion 15 may be changeable, or the inclination thereof may be fixed.

The vehicle 100 of the present embodiment includes the center console 20 which will be described below. The center console 20 inside the vehicle compartment 10 is disposed between the driver's seat 12 and the passenger seat 13. The center console 20 is provided linearly toward the rear from a lower portion of the instrument panel 11. A rear portion of the center console 20 of the illustrated example is disposed between the backrests 16 of the front passenger seats.

Although it will not be particularly shown, the rear portion of the center console 20 may reach rear passenger seats. For example, the center console 20 can also be extended to a location between a rear seat on the right side and a rear seat on the left side. If the rear portion of the center console 20 is located between the front passenger seats without reaching the rear passenger seats, it is easier for passengers to move in the rear passenger seats in a lateral direction.

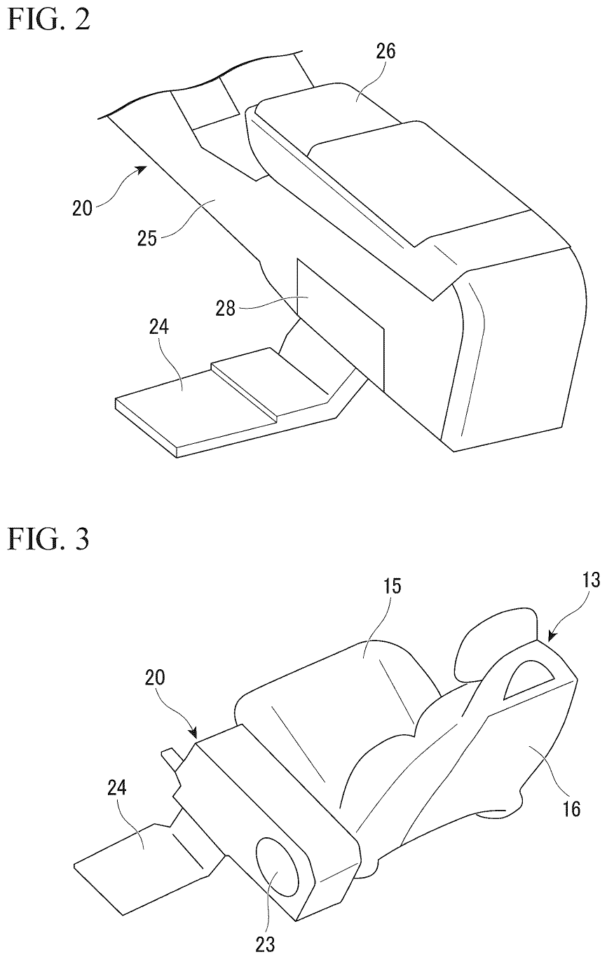

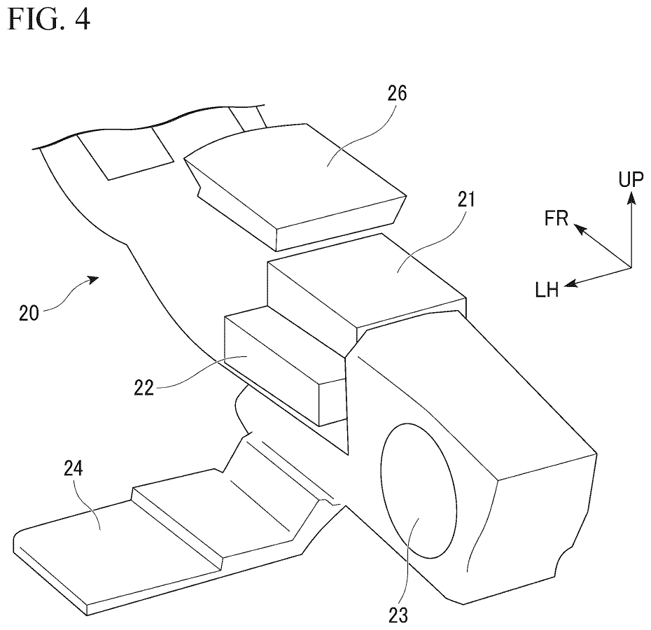

FIG. 2 is a perspective view showing an example of an exterior appearance of the center console 20. FIG. 3 is a perspective view showing an example of a positional relationship between a sound source 23 and the passenger seat 13 built into the center console 20. FIG. 4 is a perspective view showing an example of disposition of the control units 21 and 22 and the sound source 23 built into the center console 20. FIG. 4 shows an arrow UP indicating the upward side of the vehicle 100 together with the arrows FR and LH having the same meanings as those in FIG. 1. In FIGS. 3 and 4, illustration of a cover 25 of the center console 20 shown in FIG. 2 is omitted.

The center console 20 of the present embodiment includes a plurality of control units 21 and 22 disposed inside the vehicle 100 at the front, and the sound source 23 disposed inside the vehicle 100 at the rear. Moreover, in the center console 20 of the present embodiment, the sound source 23 is disposed facing toward lateral sides of the vehicle 100. The center console 20 of the illustrated example includes the cover 25 accommodating at least the control units 21 and 22 and the sound source 23.

One or a plurality of speakers can be used as the sound source 23 by suitably selecting them from known speakers and the like. In order to improve the playback quality of lower-register sound, it is preferable that the sound source 23 include a subwoofer. In order to improve the volume and quality of sound of the sound source 23, it is preferable to secure a large area and diameter for the sound source 23.

If the sound source 23 is disposed facing toward the front side, the rear side, or the upward side of the vehicle 100, the sound source 23 is disposed with the diameter in the lateral direction, and therefore it is difficult for it to be built into the center console 20 disposed between the driver's seat 12 and the passenger seat 13. If the sound source 23 is disposed facing toward the lateral sides, the sound source 23 is disposed with the diameter in the forward-rearward direction and an upward-downward direction along a vertical center plane of the vehicle 100, and therefore the sound source 23 can be disposed compactly inside the center console 20.

If the control units 21 and 22 are disposed at the rear in the vehicle 100, the distance to the instrument panel 11 becomes longer, and therefore a space occupied by wirings and the like inside the center console 20 is likely to increase. If the control units 21 and 22 are disposed at the front in the vehicle 100, they are closer to the instrument panel 11, and therefore design of disposition of the wirings and the like is facilitated.

Moreover, in the center console 20, since the position of the sound source 23 is disposed on the backrests 16 side of the front passenger seats, sound is output to the front and the rear from near the center of the vehicle compartment 10. Therefore, high-quality sound can be emitted toward each of passengers sitting in the front passenger seats and the rear passenger seats.

The control units 21 and 22 are used for controlling diverse functions, such as controlling functions necessary for traveling of the vehicle 100, controlling functions necessary for comfortable habitability inside the vehicle compartment 10, as well as controlling functions necessary for utilization of the sound source 23. For this reason, the plurality of control units 21 and 22 share the duties in cooperation to control each of the functions so that the functions necessary for the vehicle 100 can be secured.

It is preferable that the vehicle 100 be a vehicle including a power source driven by electric energy. Examples of such vehicles include electric vehicles, fuel cell vehicles (FCV), and the like. Examples of the electric vehicles include battery electric vehicles (BEV), hybrid electric vehicles (HEV) or plug-in hybrid electric vehicles (PHEV) including an internal-combustion engine providing at least a part of power, and the like.

The center console 20 of the illustrated example includes the first control unit 21 on the upward side and the second control unit 22 on the downward side. For example, the control units 21 and 22 may be disposed at positions shifted in the lateral direction. Terminals, wirings, and the like connected to the control units 21 and 22 can be disposed around the control units 21 and 22 inside the cover 25 of the center console 20.

The number of control units 21 and 22 disposed in the center console 20 is not particularly limited. The center console 20 of the illustrated example includes two control units 21 and 22, but the center console 20 may include three or more control units.

Information equipment such as a recording medium playback device and an information display device may be disposed in the instrument panel 11. Examples of the recording medium include a music recording medium and a video recording medium. The information equipment may playback only sound or may display characters, symbols, video images, and the like along with sound. The sound is not particularly limited and may include human voice, animal voice, sound of musical instruments, sound generated in the natural world, artificially synthesized sound, and the like. The vehicle 100 of the illustrated example includes a display 17 in the instrument panel 11.

The center console 20 of the illustrated example includes an operation device 26 for operating the information equipment such as the display 17. The operation device 26 may include switches, display lamps, icons, a touch panel, and the like as operation portions and display portions. In order to facilitate operations by the passengers sitting in the front passenger seats, it is preferable that the operation device 26 be disposed on the lateral side of the seat cushions 15. The sound played back by sound source 23 may be operated on the basis of electric signals transmitted from the operation device 26. It is also possible for the sound source 23 to play back sound received wirelessly from outside the vehicle, for example, sound obtained via a TV set, a radio, the Internet, and the like.

In the case of the sound source 23 used for lower-register sound, such as a subwoofer, a box 24 is provided so as to secure a space for confining sound energy emitted from the rear sides of speaker units inside the sound source 23. The box 24 is also referred to as an enclosure. The box 24 may not be accommodated in the cover 25.

It is preferable that the box 24 be disposed below the seat cushions 15 of the front passenger seats in an extending manner. Accordingly, a space for disposing the box 24 for the sound source 23 can be secured by effectively utilizing a dead space below the seat cushion 15. The height of the box 24 is not particularly limited. The box 24 may come into contact with a floor surface of the vehicle compartment 10 or may be disposed above the floor surface of the vehicle compartment 10.

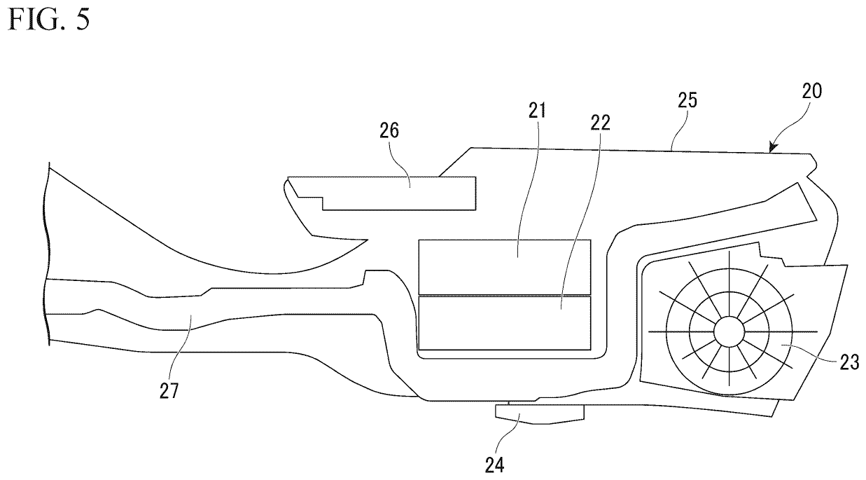

FIG. 5 is a side view showing an example of disposition of an air conditioning duct 27 in the center console 20. It is preferable for the center console 20 to have the air conditioning duct 27 built therein. Accordingly, air conditioning of the rear passenger seats can be performed smoothly. The air conditioning functions inside the vehicle compartment 10 are not particularly limited and include functions selected from cooling, heating, dehumidification, humidification, ventilation, and the like.

It is preferable that the air conditioning duct 27 in the center console 20 be disposed on an upper surface of the sound source 23 between the control units 21 and 22 and the sound source 23 from lower surfaces of the control units 21 and 22. Accordingly, the air conditioning duct 27 can be disposed compactly together with the control units 21 and 22 and the sound source 23 inside the center console 20.

The air conditioning duct 27 on the lower surfaces of the control units 21 and 22 can be disposed along the lower surface of any one of the control units 21 and 22. When the plurality of control units 21 and 22 are disposed side by side in the upward-downward direction, it is preferable that the duct 27 lie along the lower surface of the control unit 22 in the bottom stage.

The air conditioning duct 27 between the control units 21 and 22 and the sound source 23 may lie along rear surfaces (rear sides) of the control units 21 and 22 or may lie along a front surface (front surface side) of the sound source 23. Although it will not be particularly shown, the center console 20 may include air outlets for blowing air toward the rear passenger seats from the air conditioning duct 27. When the air conditioning duct 27 extends to the backrests 16 of the front passenger seats or the like, the air outlets may be disposed in upper portions of the front passenger seats or the like.

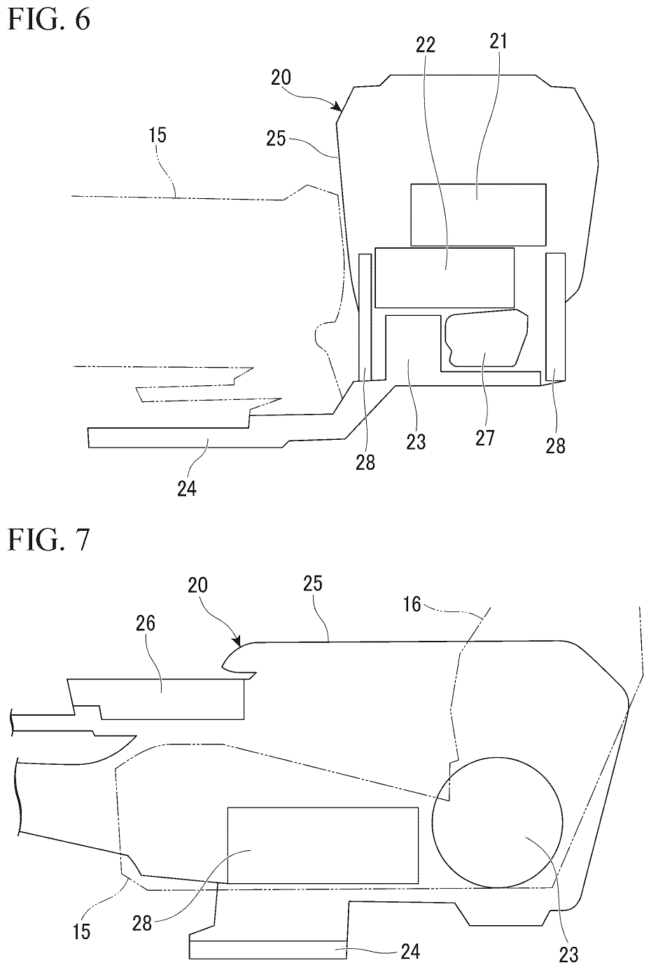

FIG. 6 is a rear view showing an example of disposition of the control units 21 and 22 and the sound source 23 built into the center console 20. When the center console 20 is viewed from the rear side of the vehicle 100, opening portions 28 are formed in the cover 25 of the center console 20 with respect to both the left and right sides of the sound source 23.

It is preferable that the opening portions 28 of the cover 25 communicate with the control units 21 and 22 and the sound source 23. Since the opening portions 28 serve as both opening portions for releasing exhaust heat of the control units 21 and 22 and opening portions for releasing sound pressure of the sound source 23, design of the opening portions 28 on an outer surface of the center console 20 can be facilitated. Although it will not be particularly shown, the opening portion for the control units 21 and 22 and the opening portion for the sound source 23 can also be separately disposed.

FIG. 7 is a side view showing an example of disposition of the opening portion 28 with respect to the seat cushion 15. It is preferable that the opening portions 28 be disposed at positions overlapping the seat cushions 15 of the vehicle 100. Accordingly, the opening portions 28 for releasing exhaust heat of the control units 21 and 22 and sound pressure of the sound source 23 are disposed such that they are less likely to be seen from the passengers so that the interior appearance can be improved.

The center console 20 of the illustrated example has the first opening portion 28 at a position overlapping the seat cushion 15 of the driver's seat 12 and has the second opening portion 28 at a position overlapping the seat cushion 15 of the passenger seat 13. Although it will not be particularly shown, the center console 20 may have the opening portion 28 on only the driver's seat 12 side or may have the opening portion 28 on only the passenger seat 13 side.

The number of regions in which the opening portions 28 are disposed on the cover 25 is not particularly limited and one or a plurality of regions may be provided. It is preferable that each of the opening portions 28 be an assembly of a plurality of holes. Examples of the assembly of a plurality of holes include a mesh and a lattice. The cover 25 itself may be molded with a plurality of holes, or a mesh member, a lattice member, or the like having a plurality of holes may be attached to the cover 25.

The present invention is not limited to the foregoing embodiment, and various design changes can be made within a range not departing from the gist thereof. Examples of vehicles include automobiles having a vehicle compartment. Examples of automobiles are not particularly limited and include automobiles, for example, having approximately four to eight wheels, more specifically, passenger cars, and trucks. The center console including the control units and the sound source described above can also be applied to other moving objects, transportation equipment, and the like.

What is claimed is:

1. A center console for a vehicle comprising:
a plurality of control units disposed inside the vehicle at the front in the center console; and
a sound source disposed inside the vehicle at the rear in the center console,
wherein the sound source is disposed facing toward lateral sides of the vehicle.

2. The center console for a vehicle according to claim 1,
wherein the center console includes a box for securing a space for the sound source, and the box is disposed below a front passenger seat of the vehicle in an extending manner.

3. The center console for a vehicle according to claim 1 further comprising:
an air conditioning duct lying on an upper surface of the sound source between the control unit and the sound source from a lower surface of the control unit.

4. The center console for a vehicle according to claim 1,
wherein the center console includes a cover accommodating at least the control unit and the sound source, and the cover has an opening portion communicating with the control unit and the sound source.

5. The center console for a vehicle according to claim 4,
wherein the opening portion is disposed at a position overlapping a seat cushion of the vehicle.
